(19) United States
(12) Patent Application Publication
(10) Pub. No.: US 2024/0227531 A1
(43) Pub. Date: Jul. 11, 2024

(54) Mid-Motor Three Wheel Drive Three Wheel Vehicle

(71) Applicants: Gregory W Kunsch, Virginia Beach, VA (US); Alexander Andre Kunsch, Virginia Beach, VA (US)

(72) Inventors: Gregory W Kunsch, Virginia Beach, VA (US); Alexander Andre Kunsch, Virginia Beach, VA (US)

(21) Appl. No.: 18/544,525

(22) Filed: Dec. 19, 2023

Related U.S. Application Data
(63) Continuation-in-part of application No. 16/578,370, filed on Sep. 22, 2019, now abandoned.

(51) Int. Cl. B60K 1/02; B60L 7/10; B60L 15/20

(52) U.S. Cl. CPC B60K 1/02; B60L 7/10; B60L 15/2009; B60L 2220/42; B60L 2240/463

(57) ABSTRACT

The general layout for a three wheel drive, three wheel vehicle with two steerable driven wheels in the front of the vehicle, utilizing one or two motors to drive the front wheels, and a rear motor to drive the rear wheel. The vehicle maximizes performance of a three wheel vehicle by controlling torque on all three wheels. This is used to manage vehicle lateral dynamics while maximizing wheel traction for acceleration. Utilizing compact motors, in-hub motors, or direct connect motors allows a significant portion of the vehicle's weight to be moved forward, while integrating the location of the passenger seating, steering, and driven wheels results in a highly stable three wheel vehicle. The layout maintains the traditional bucket or bench style seats as found in today's automobiles, and yet allows for weighting and cockpit adaptability for different market demographics.

### CROSS-REFERENCE TO RELATED APPLICATIONS

This application is a continuation in part (CIP) of U.S. parent application Ser. No. 16/578,370, Mid-Motor Three Wheel Drive Three Wheel Vehicle, filed Sep. 22, 2019. In support of the parent application, additional explanation and clarification is provided in the specification and drawings below.

### PRIOR ART

Three wheel vehicles come in a variety of types, whether two wheels in rear, two wheels in front, driven rear wheel(s), or driven front wheel(s). These types are well articulated in U.S. Pat. No. 9,604,683 (patent citation #1) and are exemplified in numerous vehicles and patents today. The present invention introduces Type 4A as follows:
Type-1—Two wheels in the rear of the vehicle with the rear wheels driven.
Type 2—Two wheels in the front of the vehicle with the rear wheel driven. Variations of this are:
   (A) Straddle type seating where the vehicle body or motor is straddled by the passenger, whether the motor is directly underneath, forward, or rearward of the driver. An example is a Can-Am Spyder (non-patent citation #1).
   (B) Traditional seating with the motor in front of the passenger compartment. Examples include Polaris Slingshot (non-patent citation #2) and Morgan 3 Wheeler (non-patent citation #3).
   (C) Traditional seating with the motor behind the passenger seat. An example is the Campagna T-Rex (non-patent citation #4).
Type 3—Two wheels in the front of the vehicle with the front wheels driven. Variations of this are:
   (A) Straddle type seating where the body or motor is straddled by the passenger, whether the motor is directly underneath, forward, or rearward of the driver. An example is the Stimson Scorcher (non-patent citation #5).
   (B) Traditional seating with the motor in front of the passenger compartment. An example is the Trihawk (non-patent citation #6). This is referred to as ‘front engine’ design.
   (C) Traditional seating with the motor behind the front of passenger seat. This is referred to as a ‘rear engine’ design.
      (1) Rear wheel steering. An example is the Dymaxion car (non-patent citation #7).
      (2) Front wheel steering. An example is Dragonfly Three Wheeler, U.S. Pat. No. 9,604,683 (patent citation #1).
   (D) Traditional seating with the motor in the mid-section of the vehicle, between the front of the passenger compartment and the front of the passenger seat. This type is referenced as ‘mid-engine’ design. An example is U.S. Pat. No. 11,299,223 (Kunsch et al).
Type 4—Two wheels in the front of the vehicle with three wheels driven.
   (A)—Traditional seating with one or two electric motors in the mid or rear section of the vehicle driving the front wheels, and one electric motor in the rear section of the vehicle driving the rear wheel. This type is referenced as the three-wheel drive mid-motor design, and is the subject of the present invention.
   (B) Other variations including:
      vehicles with the motor or motors located in forward portion of vehicle,
      vehicles with straddle type seating,
      vehicles utilizing mechanical means to distribute power between the front and rear wheels.

U.S. Pat. No. 9,604,683 (patent citation #1) describes the stability challenges with various types of three wheel vehicles due to the unique dynamics presented by different layouts. Vehicle dynamics are radically different between 3 and 4 wheel vehicles, just as dynamics are radically different between 2 and 3 wheel vehicles. The significant difference in dynamics is also true of three wheel vehicles with two wheels in front versus two wheels in the rear, and a similar level of change in dynamics occurs as the wheels and motors are moved rearward. This change in dynamics results from the weight movement of the motors themselves, change in location of the variable passenger loading, a roll axis movement on all three axes, and a center of gravity movement from the front wheels location.

In vehicle type 3C2 (Kunsch et al, U.S. Pat. No. 9,604,683, patent reference 1) and vehicle type 3D (Kunsch et al, U.S. Pat. No. 11,299,223), Kunsch et al recognized the change in vehicle dynamics associated with the motor and wheel movement and eliminated all power to the rear wheel to compensate for the new dynamics. Although torque vectoring and AWD were available at the time, it was not obvious to Kunsch et al (U.S. Pat. No. 9,604,683), nor Kunsch et al (U.S. Pat. No. 11,299,223) that AWD nor AWD with some type of torque vectoring could effectively be used in these vehicle types. In the present invention, the unique dynamics associated specifically with this type of vehicle were examined through analysis, experimentation and simulations, and a specific unique approach was invented. The new vehicle design is described above as Type 4A.

The present invention retains the passengers towards the front, over widest part of the vehicle. The largest weight variable is the number and size of the passengers. With the present invention, changes in the center of gravity for the vehicle due to loading variability are minimized and occur in the mid-section near the widest portion of the vehicle. This unique vehicle approach results in a stable three wheel vehicle design.

The present invention uses separate front and rear motors to balance power delivery and manage desired traction levels between the front and rear of the vehicle. This balance of power is a crucial element of the present invention. In U.S. Pat. No. 9,604,683 (patent citation #1), the use of front wheel drive enhances traction characteristics by eliminating all power to the rear wheel. Eliminating all power to the rear wheel is not necessary in all cases. In the present invention, effectively balancing power to the rear wheel allows the rear wheel to be used in a controlled and optimized manner in addition to the driven front wheels.

Although no previous art could be found, it is considered obvious that other art will likely employ all wheel or three driven wheel designs utilizing two or three motors, including hub or in-wheel motors, with the front motors in the front of the vehicle forward of the passenger compartment. With this obvious design, the passengers are effectively behind the wheels, causing the passenger compartment to be pushed rearward. This is significantly different than the present invention where the passenger compartment is pulled forward. Although no previous art could be found, this art is mentioned to contrast the present invention, and is referred to as anticipated previous art.

### BACKGROUND OF THE INVENTION

### Field of the Invention

The present invention pertains to motor vehicles. More specifically, the present invention pertains to those having only three wheels.

### SUMMARY OF THE INVENTION

The present invention defines a unique three wheel vehicle where the wheels are arranged with two in the front of the vehicle and one in the rear. All three wheels are driven. The front wheels are driven by placing the one or two electric motors in the midsection or rear of the vehicle driving the front wheels. The rear wheel is driven by a single electric motor in the rear of the vehicle. A typical embodiment would be an electric motor driving each front wheel, with the center of the wheels placed just forward of the passenger seats and parallel to the passenger compartment, and a single rear motor in the rear of the vehicle. Single, dual or multiple passenger variants are possible within the mid-motor configuration.

### BRIEF DESCRIPTION OF DRAWINGS

Present Invention Drawings are as follows:

Drawing (1): Embodiment: Single Passenger seating; Three Motor

FIG. 1—Embodiment—Perspective View—fully sketched exterior

FIG. 2—Embodiment—Plan View—cutaway showing key elements

Drawing (2): Embodiment: Dual Passenger with Side by Side seating; Dual Motor

FIG. 3—Embodiment—Plan View

Drawing (3): Depiction of motor location with respect to vehicle section (Front/Mid/Rear) contrasting Present invention and Anticipated Previous art

FIG. 4.1—Plan View Present Invention

FIG. 4.2—Plan View ‘anticipated’ Previous Art

Drawing (4): Depiction of location of Front Wheel Vertical Planes, shown with Embodiment of Side by Side seating and Single Front Motor

FIG. 5—Plan View

Drawing (5): Variable Passenger Loading and Roll Axis Triangle, shown with Embodiment of front motors behind front wheels

FIG. 6—Plan View

Drawing (6): Rear Wheel Loading

FIG. 7.1—Plan View

FIG. 7.2—Plan View

FIG. 7.3—Plan View

Drawing (7): Embodiment Examples

FIG. 8.1—Perspective View—3 Passenger

FIG. 8.2—Perspective View—2 Passenger Side-by-Side Seating

FIG. 8.3—Perspective View—2 Passenger Serial Seating

FIG. 8.4—Perspective View—4 Passenger

On each of the drawings, items called out are as follows:
(A)—Front Wheels
(B)—Passenger Seats
(C1)—Motor(s) Front
(C2)—Motors(s) Mid/Rear
(C3)—Motors(s) Rear
(D)—Rear Wheel
(E)—Passenger Compartment
(F)—Motor to Driven wheel connection
(G)—Vehicle Section
(VP1)—Vertical Plane between the Rear of Front Wheels
(VP2)—Vertical Plane between the Front of Front Wheels
(AL)—Lateral Roll Axis
(AF)—Front Roll Axis
(AR)—Rear Roll Point
(P1)—Mass of the First Passenger
(M1)—Moment arm of First Passenger around Lateral Roll Axis (AL)
(P2)—Mass of the Second Passenger
(M2)—Moment arm of Second Passenger around Lateral Roll Axis (AL)
(F1)—Rear wheel forces in free wheel state
(F2)—Rear wheel forces under braking or regeneration
(F3)—Rear wheel forces under braking or regeneration, and under motor torque

Before any embodiments of the invention are explained in detail, it is to be understood that the invention is not limited in its application to the details of construction and the detailed arrangement of components set forth in the following description or illustrated in the following drawings. The invention is capable of other embodiments not listed herein, and of being practiced or of being carried out in various ways. Also, it is to be understood that the phraseology and terminology used herein is for the purpose of description and should not be regarded as limiting.

### DETAILED DESCRIPTION OF THE INVENTION

FIG. 2 portrays the general layout of the components of the present invention within a single passenger, three motor embodiment. Regardless of the number or type of motors, and number or arrangement of seats, there are key components which define the present invention. The key components are two steerable front wheels (item A) overlapping the mid-section or rear of the vehicle, a rear wheel (item D) which is located behind the front wheels, a passenger compartment (item E) with one or more conventional passenger seats (item B), and one or more motors (item C2) overlapping the mid-section or rear of the vehicle which drive the front wheels, and a motor in the rear of the vehicle (item C3) driving the rear wheel. This specification refers to the front wheels to facilitate understanding, however a more accurate terminology would be mid wheel, as the front wheels of the present invention are located in the mid section of the vehicle.

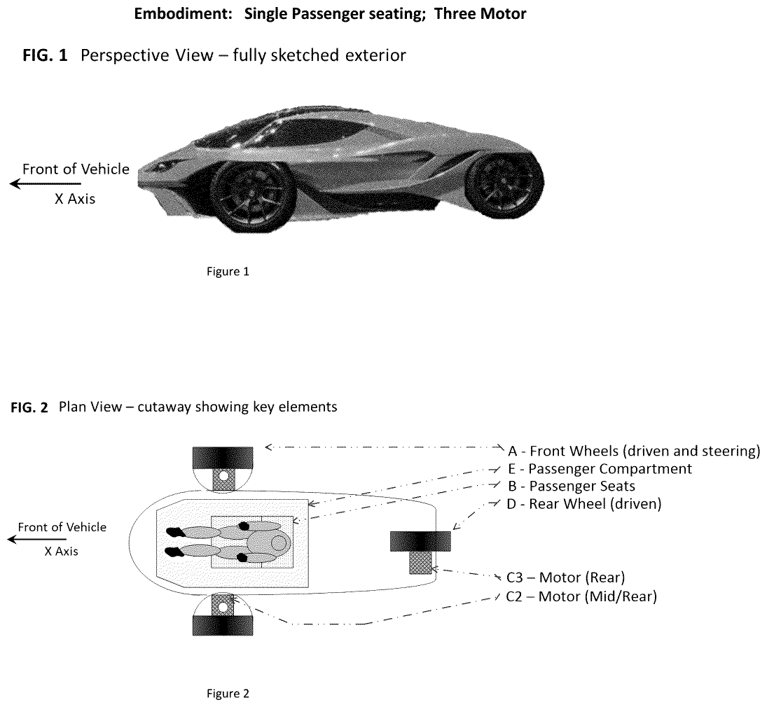

FIG. 1 portrays a fully sketched perspective view of the exterior of a single passenger three motor embodiment. The exterior styling is not a critical or key component of the vehicle functions and may take many forms dependent on the target market.

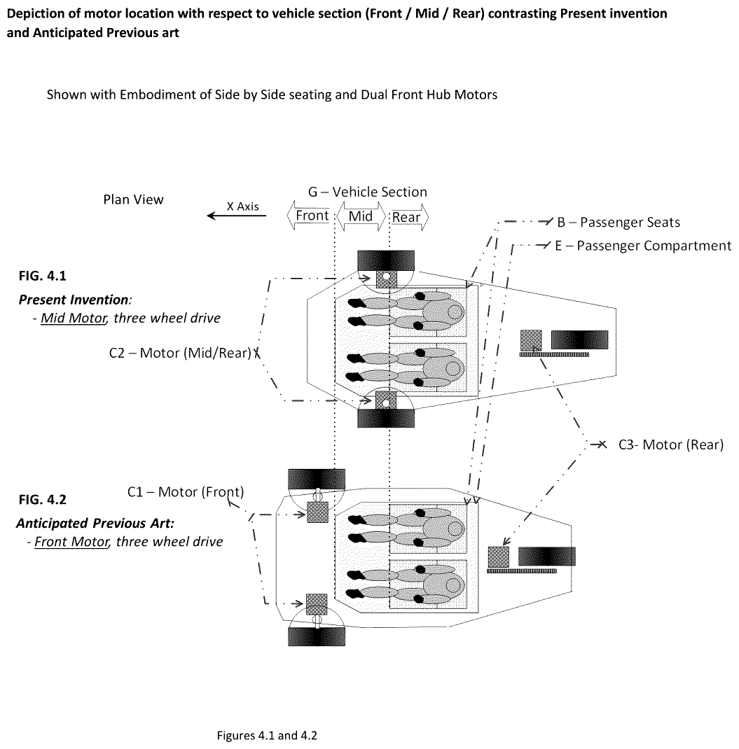

Drawing (3) is a depiction of motor locations with respect to vehicle section (Front/Mid/Rear) contrasting Present invention (FIG. 4.1) and Anticipated Previous art (FIG. 4.2) in a plan view. There are three sections of the vehicle (item G), the front, mid, and rear which are defined along the x-axis of the vehicle. The passenger compartment (item E) is the area of the vehicle intended for the passengers. The passenger compartment is the area in which the passengers sit and encompasses the passenger seats (item B). The X axis is the centerline of the vehicle extending from the front to the rear.
The front section is the area of the vehicle extending forward of the passenger compartment.
The mid-section is the area of the vehicle extending from the front of the seat to the front of the passenger compartment. If there are multiple seats, then mid-section is defined by the front of the forward most seat.
The rear section is the area of the vehicle extending from the front of the seat to the rear of the vehicle. If there are multiple seats, then rear section is defined by the front of the forward most seat.

There are one or two electric motors which drive the front wheels. The front motor is in a location that overlaps or partially overlaps the mid or rear section of the vehicle and is also referred to as the mid motor in the present invention. This does not imply that the motor must be in or part of the passenger compartment. The motor may be within or external to the passenger compartment itself. The overlap along the X axis may be full or partial. A full overlap is when the entire motor is within the mid or rear section plane of the vehicle. A partial overlap is when any portion of the motor overlaps the mid or rear section plane. Any overlap regardless of the amount with the mid or rear section of the vehicle defines the vehicle and is within the context of the present invention. The motor location in context of the vehicle section is a key element of the present invention.

There is one electric motor in the rear section of the vehicle driving the rear wheels. The front and rear motors are not mechanically connected to drive both the front and rear wheels; the front motor or motors drive the front wheels, and the rear motor drives the rear wheel.

FIG. 4.1 contrasts the present invention from other possible art. The anticipated previous art in FIG. 4.2 shows the front motors in front of the passenger compartment, and thus in the front section of the vehicle. The present invention (FIG. 4.1) places the front motors in the mid-section of the vehicle, resulting in completely different vehicle dynamics. This is very important on a three wheel vehicle where weight and handling characteristics are crucial to the vehicle stability. FIG. 4.1 also clearly shows the front wheels of the present invention in the mid section of the vehicle; hence the front wheels could be more accurately described as mid wheel.

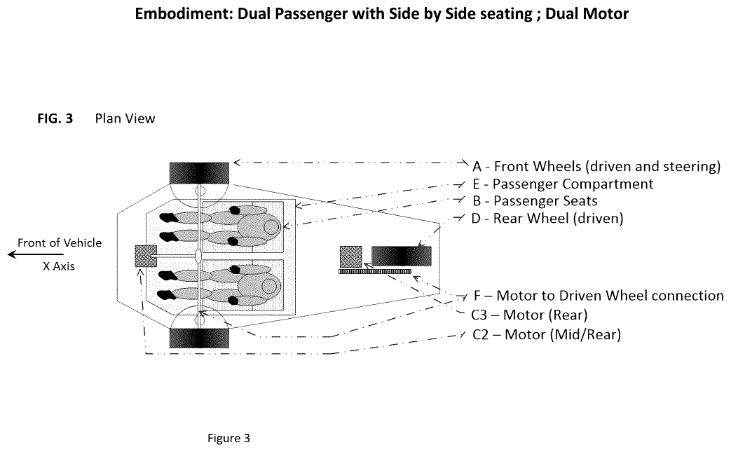

FIG. 3 is an embodiment showing Dual Passenger with Side by Side seating, Dual Motor, in a Plan view. Similar to FIG. 2, key elements are shown: two steerable front wheels (item A) overlapping the mid or rear section of the vehicle, a rear wheel (item D) which is located behind the front wheels, a passenger compartment (item E) with one or more conventional passenger seats (item B), and one or more motors (item C2) overlapping the mid or rear section of the vehicle which drive the front wheels, and a motor in the rear of the vehicle (item C3) driving the rear wheel. Additionally, a motor to driven wheel connection (item F) is shown on the rear wheel.

The present invention may utilize a variety of motor to driven wheel connection types (item F) and is not limited by possible types. Example connection types may include chain, belt, hydraulic, shaft, or direct. The method used to connect the motor to the wheels is not critical to the intent of the present invention. In certain embodiments, such as an in-hub motor, there may not be any additional connections required between motor and wheel.

If seating is adjustable, references to ‘front of seat’ indicate the forward most position of the seat. If multiple seats are used, the ‘front of seat’ refers to the seat in the forward most position in the vehicle.

The present invention is limited to standard sit-in or sit-on type passenger seats (Item B), which is also referred to as ‘traditional’ seating. The present invention does not extend to vehicles with straddle seating, in which the passenger has one leg or foot on either side of the motor or primary body of the vehicle, regardless of whether the passenger is in a forward leaning, vertical, rearward leaning, reclined, or horizontal position. Straddle type seating may have the motor directly underneath, forward, or rearward of the driver. Straddle seating is excluded from the present invention because the variable weight location of the passenger will dynamically change while the vehicle is moving due to the passenger leaning/shifting weight side to side or forward to rear. Fixed passenger location and associated weighting are key elements of the present invention.

The present invention is limited to electric motors. There are several key factors in the present invention related to electric motors. First, the weighting of the electric motor represents a key facet of the present invention; compact motor sizes allow weight to be moved more incrementally. Second, electrically balancing power is critical to performance; attempting to balance multiple internal combustion motors would be challenging. Third, the electric motor's ability to drive both forward and backward from the same motor is important in the present invention vehicle dynamics. It is important to understand that references to ‘driven wheel’ represent torque driving the vehicle forward or rearward. The electric motor may drive the wheel forward to accelerate the vehicle, or rearward in a braking fashion. This ability to use the electric motors in both directions allows stability to be optimized in the present invention. An embodiment may only use the rear wheel in deceleration modes. Conversely, other embodiments may use a smaller motor in the rear for limited wheel torque in straight line acceleration, and no torque while the vehicle is in a turn. The specific embodiment used within the present invention will rely on each vehicle's key weights such as motor size and battery location, and desired performance characteristics whether high performance or utilitarian.

In addition to items noted above, the present invention is not limited by:
frame or body structure type or material.
distances between items.
classification of vehicle such as motorcycle or car.
construction details.
suspension types and variations.
body types.
other vehicle components.

While this invention has been described with several embodiments, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

The electric motor and wheel location impacts can be visualized in Drawing 3, in which FIG. 4.1 contrasts the present invention with FIG. 4.2, a representative Type 4B-2 Front wheel, 1 Rear wheel, All Wheel Drive (AWD) vehicle having a front engine layout that would be expected to be seen in a typical, obvious, electric motor AWD three wheel vehicle. As the front wheels and motor(s) of FIG. 4.2 move rearward relative to the present invention FIG. 4.1, it can be seen that significant engineering changes occur as primary components move relative to each other. First, the front roll axis which extends between the two front wheels moves rearward introducing different vehicle dynamics. In conjunction, the weight of the motors moves rearward, while conversely the passenger or variable weight moves forward. The location and weight of associated components such as battery pack and inverters will also move, causing additional weighting and packaging changes. Even items such as door location for ingress or egress from the vehicle, steering wheel routing, suspension layout, wheel well intrusion on passenger compartment, and other vehicle functions will be altered and need to be addressed in the new arrangement. The exterior body shape is likely to be more unique with a forward passenger compartment, likely with doors that intersect with or are in front of the wheels.

There are many electric motor types which must be considered including wheel motors or in-hub motors, or conventional motors external to the wheel using a shaft or belt drive assembly. Wheel or in-hub motors are noted as they are directly related to wheel location and wheel size, whereas conventional motors are independent. The wheel or hub motor location moves proportionally to the wheel location; a conventional motor does not move proportionally to the wheel. Wheel or hub motors are also directly related to the wheel diameter. A larger motor in a larger diameter wheel weighs more and produces more power, and the larger diameter wheel raises the vehicle center of gravity height. The wheel internal rim diameter furthermore limits the maximum size and power of the in-hub motor, giving boundary constraints on these motor types. Conventional motors with shaft or belt drive can be located independently of the wheel and allow for more variation of location, weight, and power associated with the motors themselves. These possible motor and wheel variations must be considered as related but independent variables. Thus, motor location and wheel location are independent; the exception being a hub motor wherein wheel diameter and resulting center of gravity height impacts must be considered, along with known motor power constraints.

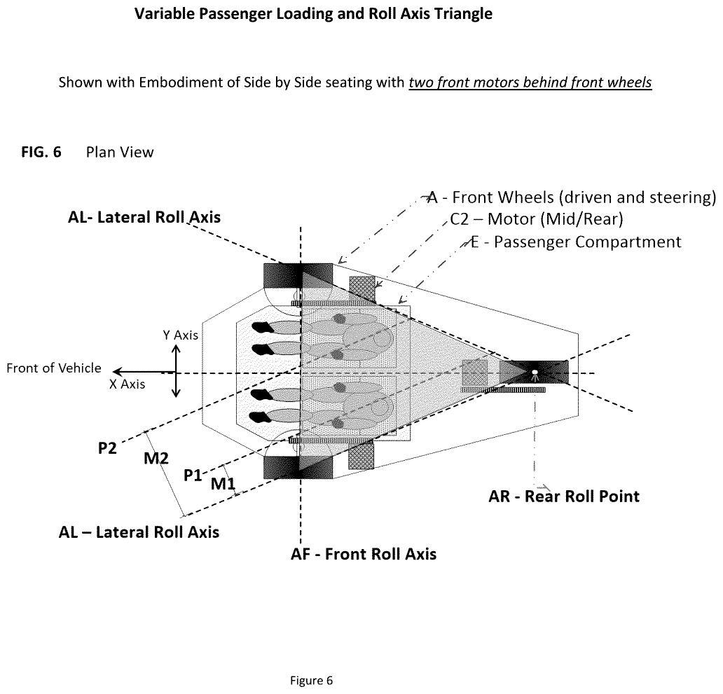

The most critical dynamic which must be addressed as the motor and wheel move rearward is related to the slippage of the rear wheel. Loss of traction of the rear wheel will cause the vehicle to spin or roll. There is no redundancy in the rear where a second wheel is handling similar loading. This can be seen in FIG. 6, where AR is the rear roll point, not an axis. There is no rear axis parallel to the forward roll axis (AF) because there is only one rear wheel. If the single wheel slips, there is no secondary wheel which provides a similar or redundant traction force laterally. Thus, the loading and slippage of that single wheel becomes the primary consideration.

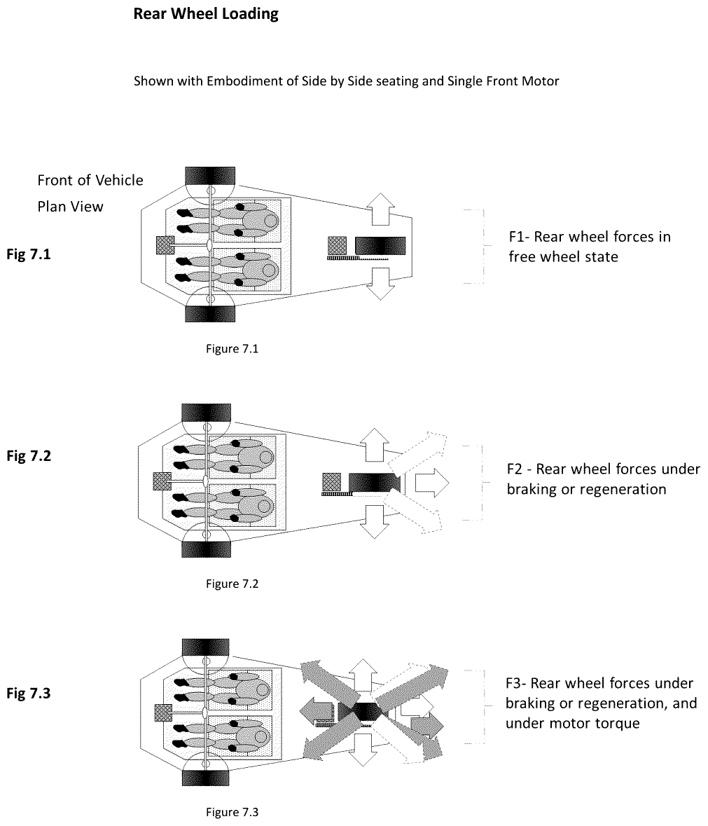

Slippage of the rear wheel is related to lateral forces, braking forces, road adhesion from road and tire surfaces, contact patch size, amount of weight on the rear wheel, and the torque exerted by the wheel created by the motor. Drawing 6 depicts the rear tire forces; FIG. 7.1 shows the wheel in free wheel state, with only lateral forces requiring traction (F1); FIG. 7.2 shows the wheel in braking or regeneration from motor (regen) with the additional forces impacting traction (F2); and FIG. 7.3 shows the wheel with AWD and the forces which require traction (F3). Since the motor power is exerting additional forces on the wheel, which in turn is incurring slippage, the powering of the rear wheel becomes a critical element of stability. Conversely stated, AWD can cause instability in the complex dynamics of this vehicle type.

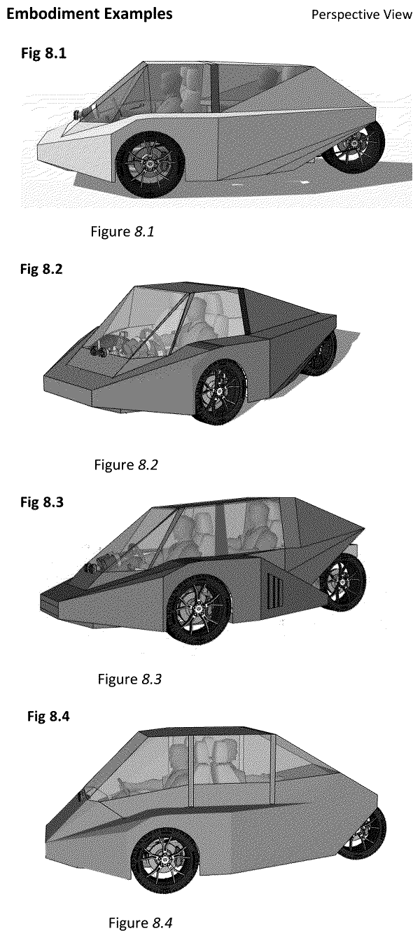

The slippage issue is multi-dimensional, as the vehicles described in the present invention can be used in various configurations, sizes, passenger capacities, and functional situations. Drawing 7 depicts example passenger embodiments different layouts of 1, 2, 3, or 4 passenger vehicles. FIG. 8.1 shows a three person layout; FIG. 8.2 shows a high performance two person side by side seating layout; FIG. 8.3 shows a high efficiency two person serial seating; FIG. 8.4 shows a four passenger neighborhood vehicle. Each of these embodiments utilizes the present invention but requires different parameters to be addressed, thus the single passenger sport vehicle has different needs than a four passenger townie style. Additionally, each of these embodiments may be tuned for specific usages, multiplying the resulting dynamics that must be addressed. The expected usage of the vehicle is what function the vehicle is intended for. For example, the same passenger vehicle may be tuned for sport use with high power/high weight motors and low center of gravity (CG), or conversely be tuned for utility use with lower power motors and higher center of gravity. A single passenger delivery vehicle will have different power, weighting, and even wheelbase length than a single passenger high performance sport vehicle. A significant weight distribution is dictated by the battery power and energy sizing, meaning a longer-range vehicle will incur substantial weight due to additional batteries. For example, the exact same vehicle which has additional batteries added for range could result in upwards of a 600 lb delta between vehicles. Dimensioning is yet another factor, as a longer wheelbase will change rear wheel weight and concurrently impact overall tire slip angles. Tire sizing and associated contact patches is yet another factor, which will be offset by road surface, rain/weather, and adhesion. The slippage relates to all these factors. Thus, the large array of factors which pertain to the vehicle dynamics present a highly complex multi-dimensional challenge in the present invention.

Many vehicle types specific to this two front wheel, one rear wheel, mid or rear engine layout have been analyzed and experimented with to determine a solution to the overall multi-dimensional problem. Vehicle embodiments have many variables, including location of fixed weight center of gravity, length of wheelbase, vehicle width, adhesion, roll on each of the vehicle tire to tire axis's, acceleration and deceleration forces, and externally induced forces. These items have been reviewed in conjunction with the intent of the present invention to maintain variable loading at the widest point of the vehicle. Drawing 5, FIG. 6 shows the intent of maintaining variable loading towards the widest part of the vehicle within the roll axis triangle. P1 is the mass of the first passenger, and M1 is the moment arm of passenger one around AL, AL being the lateral roll axis established by the line between the front and rear wheel. P2 is the mass of the second passenger, and M2 is the moment arm of passenger two around the same lateral axis (AL). If the passengers move rearward along the X axis, M1 and M2 are reduced, causing a greater likelihood of the vehicle to roll over laterally. Thus, in order to limit the lateral roll, the passengers are kept forward in the present invention. The consequences of bringing the variable passenger loading forward include the movement of the front roll axis rearward, packaging and loading impacts, changes to fixed loading gravity centers, and all the associated or derivative dynamic forces.

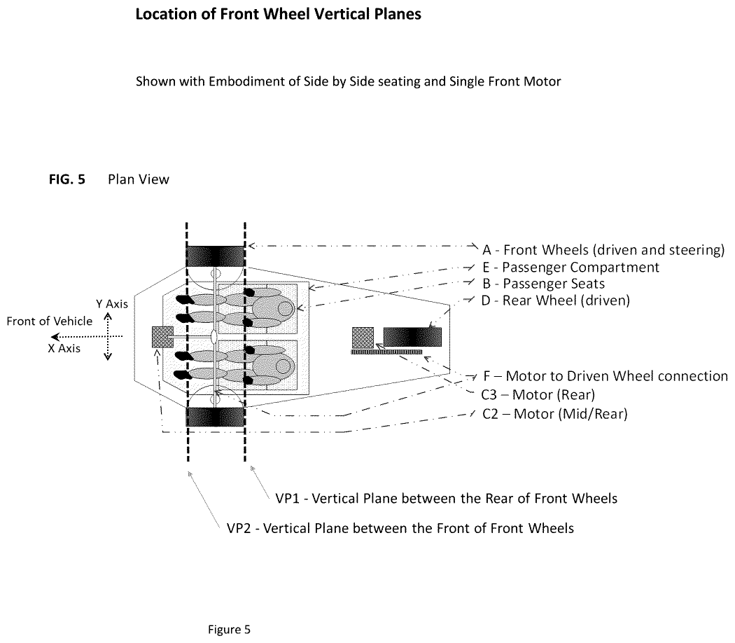

Through modelling, analysis, and experimentation, it has been discovered and determined that a common approach can be applied to adjudicate multiple use scenarios and the range of possible vehicle embodiments in the present invention vehicle class. This approach focuses on (a) bounding the forward location of the front wheels in relation to the passenger compartment, (b) the use of electric motors separately established for the front wheels located in the mid or rear section of the vehicle referred to as mid motor, and the rear wheel located in the rear section of the vehicle, (c) balance of power between the mid and rear motors, and (d) the resultant torque proportionately applied to the rear wheel by the rear motor. This allows a finite bounding of the problem set, and a solution to be provided through the relationships of passenger compartment location, front wheel location, and power balance. FIG. 5 shows the planar overlap of the wheels with the passenger compartment, wherein the vertical plane between the front (VP2) or rear (VP1) edge of the front wheels along the Y axis intersects with the passenger compartment, which then establishes the forward roll axis. Thus, the wheel location establishes the forward roll axis relationship to the passenger compartment and the variable passenger loading within. The motors and associated weight are also delineated with respect to the passenger compartment and forward roll axis, while maintaining the variable weight of the passengers toward the wide portion of the vehicle. Through analysis of the factors, it has been determined that by bounding the plane of the front wheels in an overlap with the passenger compartment establishes that the balance must be such that a maximum aggregate torque loading of the front axle (front two wheels) vs maximum torque loading of the rear axle (single rear wheel) cannot exceed a fifty percent balance in any situation. The maximum rear wheel torque during forward acceleration or constant velocity is limited no more than 50% of the total maximum torque produced by all wheels. At least 50% of the total maximum power of all the motors is produced by the mid motor(s). The maximum rear motor power is less than or equal to the total sum of the mid motor(s) maximum power. The resultant benefit is the ability to create a stable vehicle of this type with the benefits of variable loading being towards the wider part of the vehicle while using AWD to maximize performance.

There are many embodiments of the power balance. The simplest of these embodiments could be the sizing of the rear motor within the balance boundaries. Thus, a small motor could be used at the rear if the weighting arrangement dictates a high roll across the front wheel axis. A larger motor that stays within the balance boundaries could be used if the center of gravity is rearward and it is a performance-based vehicle. This embodiment could also be achieved by limiting the electrical power delivered to the motor by resistance or controller sizing, effectively having a lower power motor.

Another embodiment may be to only use the rear motor during specific vehicle dynamics. Extreme examples could be the rear motor is used only for straight line acceleration, or inversely, a small rear motor used only for regenerative purposes which exerts a rearward deceleration torque on the wheel. This embodiment could also use an accelerometer to additionally limit power or torque of motor to maintain within the maximum balance boundaries. Another embodiment could use a torque sensor within the motor or wheel to sense the amount of torque and limit or adjust accordingly. All these embodiments are refinements within the maximum balance equation.

The power balance may be static or dynamic within the overall balance boundaries. Static provides a constant or proportional power balance, such as a limited motor size or proportional throttle response. Dynamic varies the balance with vehicle state or dynamics, such as limiting rear power if lateral acceleration is detected. In certain dynamic situations it is possible that the power balance will vary, however maximum power to the rear motor is always within the maximum boundaries. For example, if a small rear motor is only used for deceleration and the front motor is not used in deceleration, then the power generated would be 100% rear during deceleration. Although the momentary balance is out of boundary, the overall maximum power provided by that motor is within overall boundaries. If the rear motor in this case were to generate more power than balance stated with the front, then the rear wheel will likely slip.

The embodiments may use only the components noted here, or utilize additional components which effectively control the motor power and wheel torque in the same manner as described. For example, a central controller that communicates with several vehicle functions and then applies torque within the maximum balance effectively accomplishes the same power balance as having motors sized proportionally.

Regardless of which vehicle embodiment and which balance embodiment is used, the result is the same for this vehicle type: All wheel drive stability can be achieved by bounding the location of the front/mid wheels and the front/mid motors and variable weight of passengers relative to the vehicle section and each other, and then controlling the power or torque balance with separate mid/front and rear motors within relative and proportional maximum boundaries.

1. A three wheel vehicle comprising:
two front wheels which allow primary directional control of the vehicle;
a single rear wheel;
a passenger compartment, the compartment comprising one or more passenger seats;
a motor or a plurality of electric motors located in a mid or rear section of the vehicle, driving the front wheels either directly or indirectly, providing either or both a forward torque for acceleration or a rearward torque for deceleration of the wheels;
an additional electric motor located in a rear section of the vehicle, driving the rear wheel either directly or indirectly, providing either or both a forward torque for acceleration or rearward torque for deceleration of the wheel.

2. The vehicle of claim 1 wherein front wheel and rear wheel drive systems are mechanically independent; the front motor(s) are not driving the rear wheel, and the rear motor is not driving the front wheels.

3. The vehicle of claim 1 wherein the rear motor is not mechanically connected to the front motor(s) or wheel(s), and the front motor(s) are not mechanically connected to the rear motor or wheel.

4. The vehicle of claim 1 wherein torque produced by the rear motor provides for one or more of: acceleration of the vehicle, deceleration of the vehicle, maintaining velocity of the vehicle, power generation or regeneration for the vehicle.

5. The vehicle of claim 1 wherein the maximum rear wheel torque is limited to no more than 50% of the total maximum torque produced by all wheels.

6. The vehicle of claim 5 wherein the maximum rear wheel torque is controlled by one or more of: limiting power of the rear motor; electrically controlling power of the rear motor in either a static or dynamic manner; braking the rear wheel to reduce effective wheel torque.

7. The vehicle of claim 1 wherein at least 50% of the total maximum power of all the motors is produced by the front motor(s).

8. The vehicle of claim 1 wherein the maximum rear motor power is less than or equal to a total sum of the front motor(s) maximum power.

9. The vehicle of claim 1 wherein the front wheels are located such that the vertical plane between the front or rear of the front wheels intersects with the passenger compartment.
